(19) United States
(12) Patent Application Publication
(10) Pub. No.: US 2005/0114464 A1
(43) Pub. Date: May 26, 2005

(54) Virtualization switch and method for performing virtualization in the data-path

(76) Inventors: Shai Amir, Raanana (IL); Sarel Altshuler, Haifa (IL); Philip Derbeko, Jerusalem (IL); Mor Griv, Tel-Aviv (IL); Ronny Sayag, Tel-Aviv (IL)

Correspondence Address: KATTEN MUCHIN ZAVIS ROSENMAN, 575 MADISON AVENUE, NEW YORK, NY, 10022-2585, US

(21) Appl. No.: 10/694,115

(22) Filed: Oct. 27, 2003

(51) Int. Cl. G06F 15/167

(52) U.S. Cl. 709/213

(57) ABSTRACT

A virtualization switch and method for executing at least SCSI commands and performing virtualization in a in a Storage Area Network. The virtualization switch optimizes the data received from the network to fit the capacity of the target storage devices, thus providing higher throughput and low latency. The virtualization is preformed within the data path between the hosts and the storage devices and without the assistance of devices, such as a management stations or agents installed in the hosts.

### TECHNICAL FIELD

The present invention generally relates to storage area networks (SANs), and more particularly for implementation of storage virtualization in SANs.

### BACKGROUND OF THE INVENTION

The rapid growth in data intensive applications continues to fuel the demand for raw data storage capacity. As companies rely more and more on e-commerce, online transaction processing, and databases, the amount of information that needs to be managed and stored can be massive. As a result, the ongoing need to add more storage service, more users, and back-up more data has become a challenging task.

To meet this growing demand, the concept of the storage area network (SAN) was introduced and is quickly gaining popularity. A SAN is defined as a network of which its primary purpose is the transfer of data between computer systems and storage devices. In a SAN environment, storage devices and servers are generally interconnected via various switches and appliances. The connections to the switches and appliances are usually through Fiber Channel (FC). This structure generally allows for any server on the SAN to communicate with any storage device and vice versa. SAN also provides alternative paths from a server to a storage device. In other words, if a particular server is slow or completely unavailable, another server of the SAN can provide access to the storage device.

In the related art virtualization storage architecture has been introduced to increase the utilizations of SANs, extend the scalability of storage devices, and increase the availability of data. The virtualization creates new virtual address spaces that are subsets or supersets of the address spaces of the physical storage devices. Storage virtualization architectures have two primary paths: a data path and a control path. The data path is a set of network components, devices and links that are used to transport data between servers and storage targets. The control path is a set of network links that allows network devices targets and storage transfers to be managed. A key component in virtualization storage architecture is a virtualization operator.

Reference is now made to FIG. 1, where a SAN system 100 including a virtualization operator is shown. System 100 includes a virtualization operator 110, a plurality of hosts 120, a Fiber Channel (FC) switch 170, and a plurality of storage devices 140. Hosts 120 are connected to virtualization operator 110 through network 150. The connections formed between the hosts 120 and virtualization operator 110 can utilize any protocol including, but not limited to, Gigabit Ethernet carrying packets in accordance with the iSCSI protocol, TCP/IP protocol, Infiniband protocol, and others. Storage devices 140 are connected to virtualization operator 110 through FC connections and FC switch 170. Storage devices 140 may include, but are not limited to, tape drives, optical drives, disks, and redundant array of inexpensive disks (RAID). A storage device 140 is addressable using a logical unit number (LUN). LUNs are used to identify a virtual storage that is presented by a storage subsystem or network device.

Generally, virtualization operator 110 performs the translations between a virtual address and a real storage address space. Placing virtualization operator 110 in the data path between hosts 120 and storage devices 140 allows performing of in-path virtualization. That is, storage I/O transmissions between hosts 120 and storage devices 140 are intercepted by virtualization operator 110 and re-transmitted to their destination. In-path virtualization generates multiple secondary I/O requests for each incoming I/O request. In other words, there are multiple data paths for each incoming I/O request. I/O requests received from hosts 120, are buffered in a networks device. Virtualization operator 110 then applies the virtualization operations and by that creates new secondary I/O requests and then transmits them to the storage targets. Finally, the results of all secondary I/O requests must be verified before acknowledging the original I/O request. The process of terminating, buffering, reinitiating and verifying I/Os adds significant latency to the storage and retrieval processes.

In the related art there are some attempts to reduce the latency and improve the performance of virtualization system architectures. For example U.S. patent application Ser. No. 10/051,164 entitled “Serverless Storage Services” and U.S. patent application Ser. No. 10/051,415 entitled “Protocol Translation in a Storage System” disclose a storage switch (e.g., virtualization operator 110) capable of executing virtualization functions, such as mirroring, snapshot, and data replication. The storage switch is based on ingress and egress line-cards connected with a switch fabric. Each line-card includes a processing unit that carries out the virtualization functions. The storage switch performs its tasks in wire-speed. For that purpose, each line-card classifies packets into data and control packets, performs virtualization functions and protocol translation functions. The virtualization is performed without buffering data in the storage switch. That is, upon receiving the data it is immediately forwarded to a target storage device using a proprietary header attached to the data. In such implementations, the storage switch handles the entire incoming command (e.g., a SCSI command) including performing the actual data transfer.

This implementation is aimed at SAN architectures and is not optimized to perform virtualization functions. For example, in order to write a data block to a concatenated virtual volume which holds data from two physical storages, the SCSI command, in this case, may start in the first physical storage and ends in the second. The storage switch determines the first physical storage to which the particular data belongs and forwards the data to this volume. After completing the data transfer to the first physical storage, the data to second physical storage is retrieved from the host and written to the second storage. This process adds significant latency to the virtualization process.

Therefore, in the view of the limitations introduced in the prior art it would be advantageous to provide a virtualization operator that efficiently performs virtualization services within the data path.

### SUMMARY OF THE INVENTION

A virtualization switch and method for executing commands and performing virtualization in a Storage Area Network. The virtualization is preformed within the data path between the hosts and the targets, for example storage devices. The virtualization switch and method optimize the data received from the network to fit the capacity of the target storage devices. The virtualization includes receiving and scheduling for execution a logic command to be performed on at least one virtual volume, the logic command including at least a virtual address; translating the logic command to a list of physical commands, wherein each physical command is targeted to a different storage device; determining the amount of data to be transferred via a network; and, executing the physical commands on the storage devices.

### BRIEF DESCRIPTION OF THE DRAWINGS

FIG. 1—is a SAN including a virtualization operator;

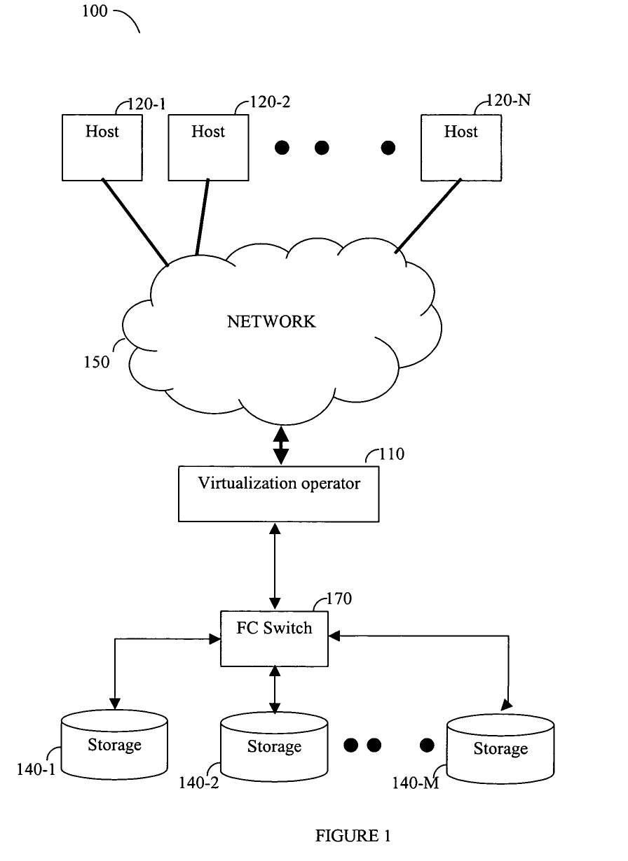

FIG. 2—is a non-limiting block diagram of a virtualization switch in accordance with an embodiment of this invention;

FIG. 3—is a non-limiting functional diagram of a virtualization switch in accordance with an embodiment of this invention;

FIG. 4—is an example of virtual volumes hierarchy;

FIG. 5—is a non-limiting flowchart describing ae method for executing a virtual read SCSI command in accordance with an embodiment of this invention;

FIG. 6—is a non-limiting flowchart describing a method for executing a virtual write SCSI command in accordance with an embodiment of this invention;

FIG. 7—is an exemplary diagram of a check point list in accordance with an embodiment of this invention.

### DETAILED DESCRIPTION OF THE INVENTION

The present invention provides a virtualization switch and a method for executing SCSI commands and performing virtualization in a single pass. The virtualization switch optimizes the data received from the network to fit the capacity of the target volumes, thus providing higher throughput and low latency. The virtualization is performed within the data path between the hosts (e.g., hosts 120) and the targets (e.g., storage devices 140) and without the assistance of any other devices, such as management stations or agents installed in the hosts. The virtualization services that are handled by the present invention include, but are not limited to, mirroring, remote mirroring over a slow link, snapshot, data replication, striping, concatenation, periodic local and remote backup, restore, and the others.

Virtualization essentially means mapping of a virtual volume address space to an address space on one or more physical storage target devices. A virtual volume can be anywhere on one or more physical storage devices including, but not limited to, a disk, a tape, and a RAID, connected to a virtualization switch. Each virtual volume consists of one or more virtual volumes or/and one or more logical units (LUs), each identified by a logical unit number (LUN). LUNs are frequently used in the iSCSI and Fiber Channel (FC) protocols and are configured by a user (e.g., a system administrator). Each LU, and hence each virtual volume, is generally comprised of one or more contiguous partitions of storage space on a physical device. Thus, a virtual volume may occupy a whole storage device, a part of a single storage device, or parts of multiple storage devices. The physical storage devices, the LUs and their exact locations, are transparent to the user. In a client-server model, the target corresponds to the server, while a host corresponds to the client. Namely, the host creates and sends commands to the target as specified by a LUN.

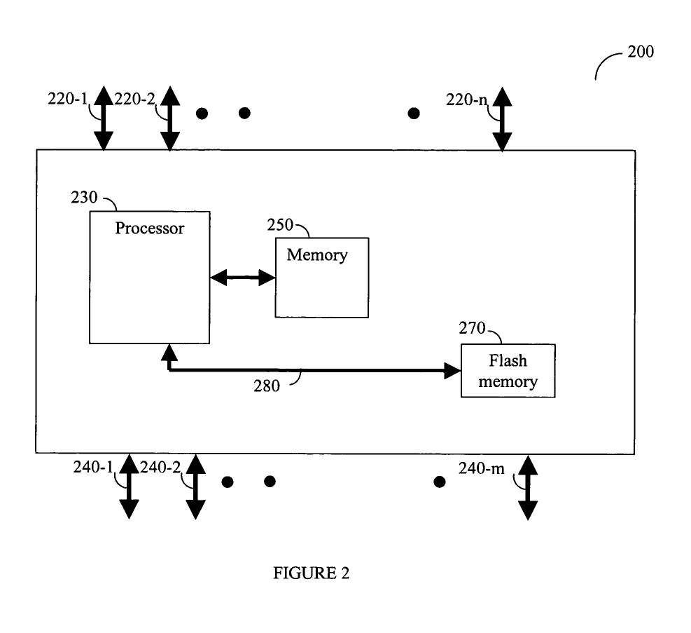

Reference is now made to FIG. 2 where a non-limiting and an exemplary block diagram of a virtualization switch 200, in accordance with an embodiment of this invention, is shown. Typically, virtualization switch 200 is operated within a storage area network (SAN) and connected in the data path between the hosts and the targets. Virtualization switch 200 includes a plurality input ports 220 and a plurality of output ports 240. Input ports 220 may be, but are not limited to, gigabit Ethernet ports, FC ports, parallel SCSI ports, and the others. Output ports 240 may be, but are not limited to, FC ports, iSCSI ports, parallel SCSI ports, and the others. An input port 220 is capable of carrying packets in accordance with transport protocols including, but not limited to, iSCSI protocol, TCP/IP protocol, Infiniband protocol, or any other transport protocol. An output port 240 is capable of carrying frames in accordance with the transport protocols including, but not limited to, parallel SCSI protocol, iSCSI protocol, FC protocol, or any other transport protocols. Therefore, virtualization switch 200 is capable of converting any transport protocol to any other (same or different) transport protocol. For instance, to convert incoming iSCSI packets to outgoing FC frames.

Virtualization switch 200 further includes at least a processor 230, a memory 250, and a flash memory 270 connected to processor 230 by bus 280. In one embodiment, virtualization switch 200 may include a cache memory to cache data transferred through virtualization switch 200. Flash memory 270 saves the configurations of virtualization switch 200.

A typical SCSI command results in a command phase, data phase, and a response phase. In the data phase, information travels either from the host (is usually referred to as “initiator”) to the target (e.g., a WRITE command), or from the target to the host (e.g., a READ command). In the response phase, the target returns the final status of the operation, including any errors. A response signals the end of a typical SCSI command. The command phase includes the LUN, an initiator tag, expected data to be transferred, and command descriptor block (CDB) that embodies the SCSI command. The data phase includes a header and the actual data to be transferred. The header generally includes the LUN, the initiator tag, a data sequence number, and the number of bytes that were not transferred out of those expected to be transferred. The response phase includes a status field, used to report the SCSI status of the command, a response field that contains an iSCSI service response code, that further identifies that the command is completed or that there has been an error or failure, the number of bytes that were not transferred out of those expected to be transferred, and the number of bytes that were not transferred to the host out of those expected to be transferred.

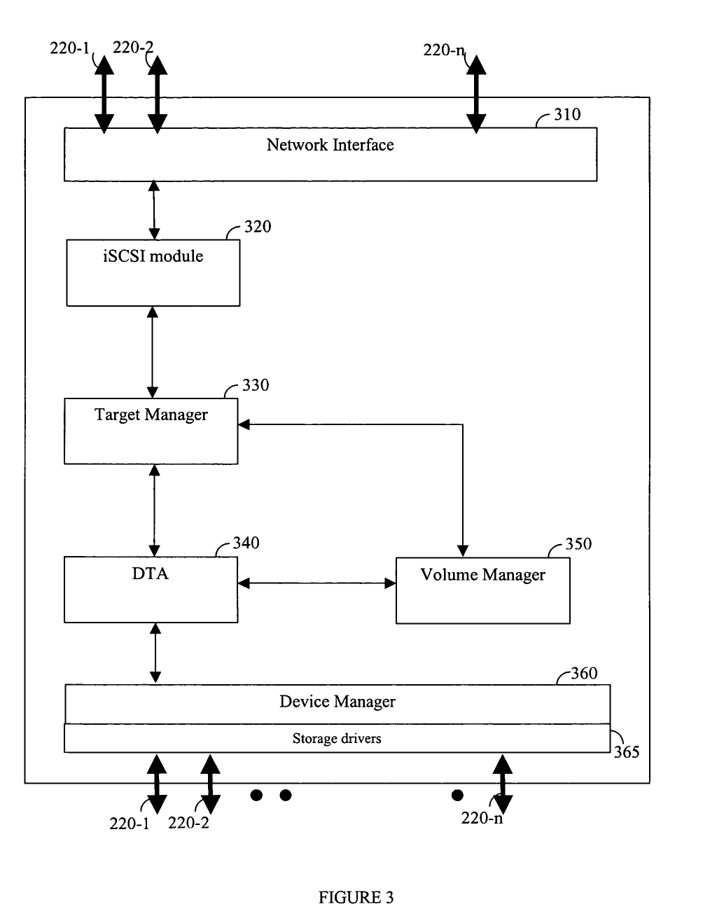

Reference is now made to FIG. 3 where a functional diagram of virtualization switch 200 in accordance with an embodiment of this invention, is shown. Virtualization switch 200 includes the following components: a network interface (N) 310, an iSCSI module 320, a target manager (TM) 330, a data transfer arbiter (DTA) 340, a volume manger (VM) 350, and a device manger (DM) 360.

NI 310 interfaces between TCP/IP network (e.g., network 150) and virtualization switch 200 through input ports 220. NI 310 includes a TCP/IP stack (not shown) which accelerates the TCP/IP packets processing. The iSCSI module 320 includes an iSCSI stack implementing the iSCSI protocol.

TM 330 implements the SCSI level logic, i.e., TM 330 parses the incoming SCSI commands to determine the type of the commands, the LUN, and the number of bytes to be transferred. An incoming SCSI command refers to a virtual volume. TM 330 schedules the execution of SCSI commands according to a predefined scheduling algorithm and generates data transport requests to DTA 340. For that purpose, each of the incoming SCSI commands is kept in a host-LU queue related to a specific pair of LU and host. In other words, the host-LU queue holds commands requested to be executed by a given host on a LU specified by the host. TM 330, further interacts with VM 350 for the purpose of executing SCSI commands that do not require any data transfer ,e.g., checking the status of a virtual volume.

DTA 340 performs the actual data transfer between targets and the hosts. DTA 340 receives from VM 350 a list of physical commands, describing how the data should be transferred from the hosts to the target physical devices, and vice versa. A logical command is converted to a list of physical commands structured in a proprietary data structure. A detailed example, for the virtualization process is provided below.

VM 350 provides a translation of the logic command. That is, each request to a virtual volume is directed to VM 350 that in return provides a list of physical commands. Each physical command includes the physical address in a single physical storage device indicating where to write the data or from where to read the data from. To execute the virtualization services VM 350 maintains a mapping schema that defines relations between the virtual volumes, the LUs, and the physical storage devices. A virtual volume may include, but are not limited to, a concatenation volume, a stripe volume, a mirror volume, a simple volume, a snapshot volume, or combination thereof.

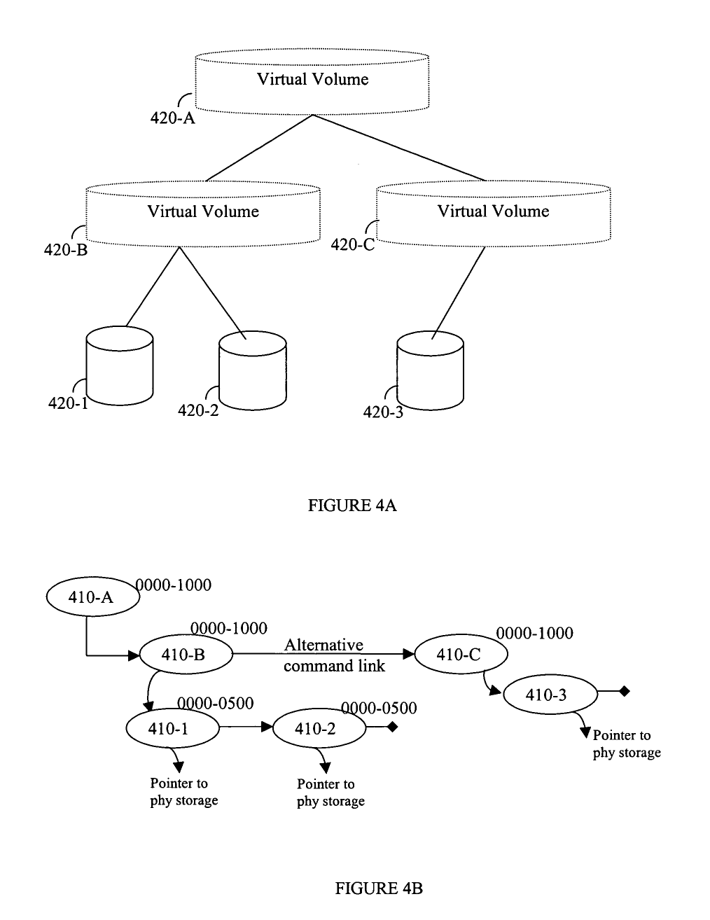

As an example, the virtual volume 410-A shown in FIG. 4A is a mirror set of two other virtual volumes 410-B and 410-C. Virtual volume 410-B is a concatenation of two LUs 420-1 and 420-2. Virtual volume 410-C is a simple volume of LU 420-3. A LU is defined as a plurality of continuous data blocks having the same block size. The virtual address space of a virtual volume resides between 0 to the maximum capacity of the data blocks defined by the LUs. The LUs and the virtual volumes have the same virtual address spaces. For instance, the virtual address space of virtual volume 410-A is 0000-1000, since virtual volumes 410-B and 410-C are mirror set of 410-A they both have virtual address spaces of 0000-1000. Given that virtual volume 410-B is a concatenation of LUs 420-1 and 420-2, the address spaces of LUs 420-1 and 420-2 are 0000-0500 and 0000-0500, respectively. The address space of LU 420-3 is also 0000-1000. The physical address spaces of the storage occupied by LUs 420-1, 420-2, and 420-3 is denoted by the physical address of the data blocks, however, the capacity of the storage occupied by these LUs is at most 1000 blocks. As mentioned above, VM 350 generates a data structure which includes a list of physical commands. This data structure includes the address spaces of the virtual volumes, the LUs, the connections between the LUs and virtual volumes, the physical addresses of the actual data, and pointers to the physical storage devices. FIG. 4B shows a non-limiting exemplary data structure formed in accordance with the virtual volumes hierarchy shown in FIG. 4A. In the data structure shown in FIG. 4B, the alternative command link denotes that operations can be executed on virtual 410-B and 410-C concurrently, e.g., while executing WRITE command.

DM 360 maintains a list of target paths and a list of LU paths associated with each target path. A target may be connected to virtualization switch 200 through more than one output port 240, where each connection defines a different target path. When a SCSI command should be sent to one of the targets, the command is sent via one of the target paths assigned to this target. In one embodiment, DM 330 may perform load balancing between the target paths and failover between output ports 240. DM 360 further includes a plurality of storage drivers 365 allow to interface with output ports 240. Storage drivers 365 conceal the type of the accessed port's type (e.g., SCSI, FC, iSCSI, etc.) to DM 360. This way DM 360 may communicate with a target device connected to an output port 240 using a common application interface.

It should be appreciated by a person skilled in the art that the components of virtualization switch 200 described herein may be hardware components, firmware components, software components, or combination thereof.

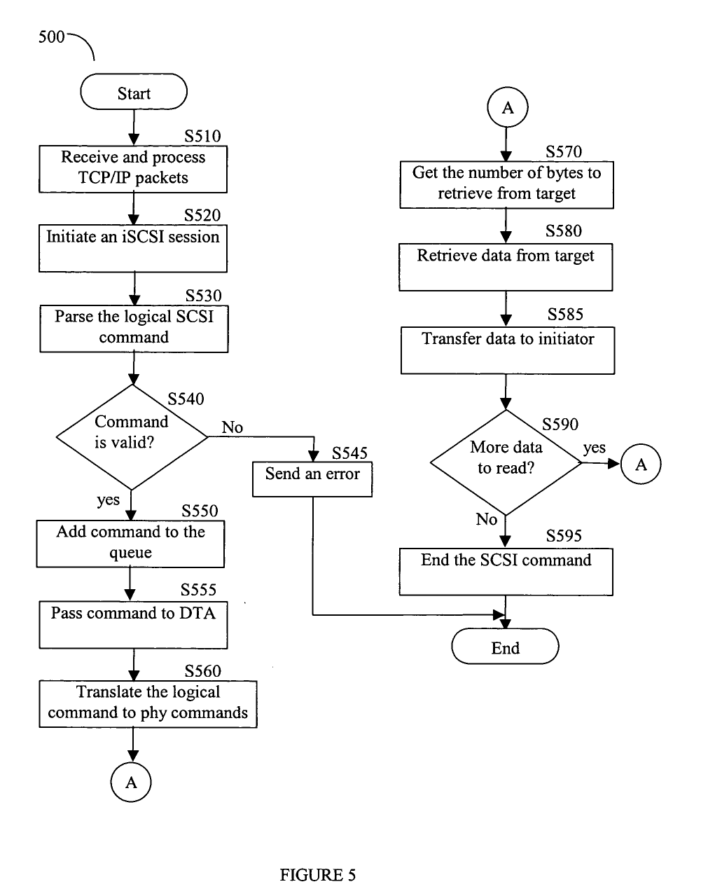

Reference is now made to FIG. 5 where a non-limiting flowchart 500 describing the method for executing a Read SCSI command in accordance with one embodiment of this invention, is shown.

At step S510, TCP/IP packets are received and processed by means NI 310. At step S520, an iSCSI session is initiated by iSCSI module 320 with a host (e.g., one of hosts 120). Next, a new SCSI command is received at iSCSI module 320. If the new incoming SCSI command was transmitted by a host that is not registered in virtualization switch 200, then TM 330 may deny the incoming command from the new host. At step S530, the new SCSI command is sent to TM 330, which parses the SCSI command. At step S540, a check is performed to determine if the incoming SCSI command is valid. If the SCSI command is invalid, then at step S545 a response command, including the iSCSI service code, is generated and sent to the host. Otherwise, execution continues with step S550 where the incoming SCSI command is added to the host-LU queue. To allow for quality of service (QoS), TM 330 may schedule the executions of tasks in different host-LU queues. The scheduling may be performed using any selection algorithm including, but not limited to, recently used, round robin, weighted round robin, random, least loaded LU, or any other applicable algorithm. At step S555, when the command is scheduled for execution, TM 330 generates a data transfer request for DTA 340. At step S560, VM 350 translates the logical SCSI command to a list of physical commands. The translation is performed in one pass and result in a data structure including the list of physical commands. To allow for control flow each physical command further includes the number of bytes expected to be read from each target. At step S570, iSCSI module 320 provides DTA 340 with an available space parameter. The available space parameter defines the current number of bytes that can be transferred to the host. This is preformed in order to optimize the data transferred through the network. At step S580, DTA 340 using DM 360 retrieve data equals to the number of bytes designated by the available space parameter. At step S585, DTA 340 transfers the retrieved data to iSCSI module 320 which subsequently sends the data to the host. At step S590, DTA 340 performs a check to determine if the entire data requested to be read was transferred to the host. If more data is to be read, then execution continues with step S570, otherwise execution continues with step S595. At step S595, DTA 340 informs iSCSI module 320 that the entire requested data has been transferred. In addition, DTA 340 informs TM 330 that the command execution has ended. As a result, TM 330 removes the command from the queue and iSCSI module 320 sends a response command to the host. The response command signals the end of the SCSI command.

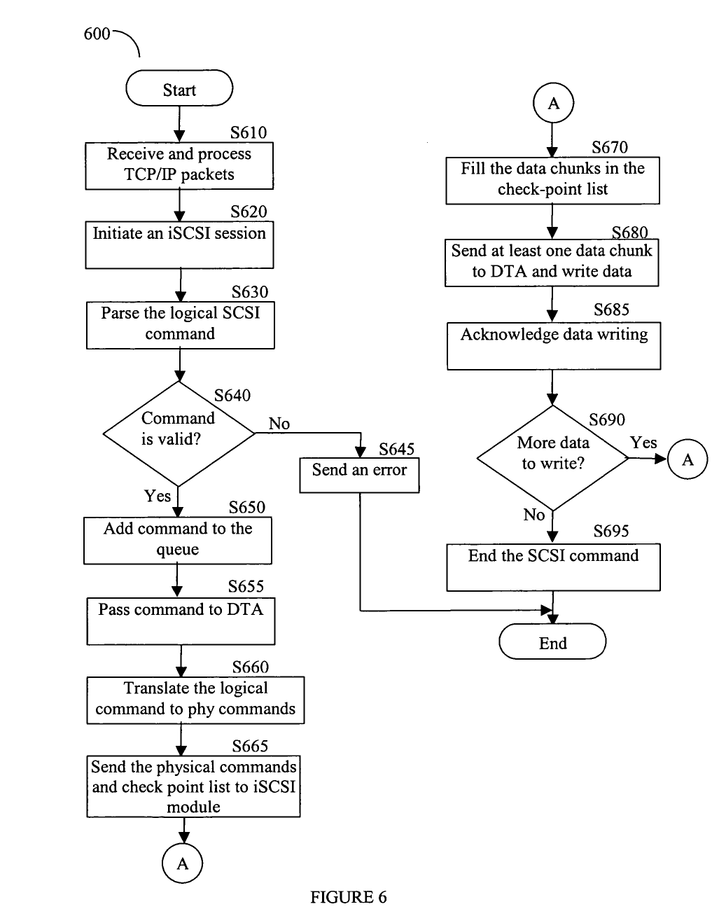

Reference is now made to FIG. 6 where a non-limiting flowchart 600 describing the method for execution of a Write SCSI command in accordance with one embodiment of this invention, is shown.

At step S610, TCP/IP packets are received data from the network (e.g., network 150). The received packets are processed by means NI 310. At step S620, an iSCSI session is initiated by iSCSI module 320 with a host (e.g., one of hosts 120). Next, a new SCSI command is received at iSCSI module 320. If the new incoming SCSI command was transmitted by a host which is not registered in virtualization switch 200, then TM 330 may deny the incoming command from the unregistered host. At step S630, the new SCSI command is sent to TM 330, which parses the command. At step S640, a check is performed to determine if the incoming SCSI command is valid. If the SCSI command is invalid, then at step S645 a response command including the iSCSI service code is generated and sent to the host. Otherwise, execution continues with step S650 where the incoming SCSI command is added to the host-LU queue. To allow for quality of service (QoS), TM 330 may schedule the executions of tasks in different host-LU queues. The scheduling may be performed using any selection algorithm including, but not limited to, recently used, round robin, weighted round robin, random, least loaded LU, or any other applicable algorithm. At step S655, when the command is scheduled for execution, TM 330 generates a data transfer request to DTA 340. At step S660, VM 350 translates the logical SCSI command to a list of physical commands. The conversion is performed in one pass as described in greater detailed above. VM 350 further generates a check-point list which describes how the data should be delivered from the host to DTA 340. The check-point list is a list of data chunks that DTA 340 expected to received from the host. A size of a data chunk is defined by a minimum and maximum number of bytes and may be changed from one chunk to another. To optimize data retrieving the number of bytes may be multiplications of a data block size. Each data chunk may target to a different physical storage. The check-point list is used to avoid situations where host sends a very small chunk of data (e.g., one byte) to DTA 340. Such situations can easily overload DTA 340 and thus reduce performance.

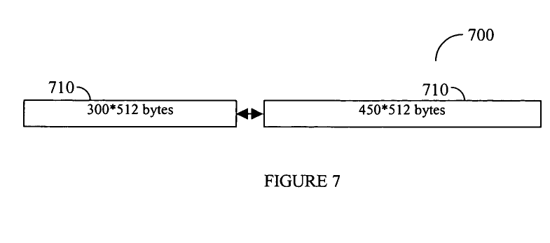

Referring now to FIG. 7 where an exemplary check-point list 700 uses for writing 750 data blocks to virtual address space 0000-0750 is shown. The data blocks have to be written to three different LUs (and hence to three different storage devices) 410-1, 410-2, and 410-3. Therefore, the check-point list 700 should include at least three data chunks. Since, virtual volume 410-C is a mirror volume of virtual volume 410-B, check point list 700 include only two data chunks 710 and 720 targeted to LU 410-1 and 410-2 respectively. The size of data chunks 710 and 720 are 300*512 bytes and 450*512 bytes respectively, where the size of a data block is 512 bytes.

At step S670, iSCSI module 320 aggregates the data bytes received from the host until the number of received bytes can fill at least one data chunk in the check-point list. The iSCSI module 320 fills the data chunks as data is received from the network. At step S680, one or more data chunks are sent to DTA 340, which subsequently sends the data chunks to the physical targets. Data chunks can be transferred to different targets over different target paths in parallel. For example, data chunks 710 and 720 can be transferred to LU 410-1 and 410-2 at the same time. It should be noted that while data chunk 710 is written to LU-410-1, iSCSI module 320 may receive data chunk 720 from the network. Since, LU 410-1 and 410-2 are mirror set of LU 410-3, DTA 340 generates another data transfer request that combines data chunks 710 and 720 and transfers them to LU 410-3. This process, i.e., steps S670 and S680, is performed without latency and thus provides significant advantageous over prior art solutions. At step S685, DM 360 acknowledges that the data chunk was written to the physical target. At step S690, DTA 340 performs a check to determine if all the data chunks were written to the target physical storage devices. If more data chunks need to be written, then execution continues with step S670, otherwise execution continues with step S695. At step S695, DTA 340 informs iSCSI module 320 that the entire requested data was transferred. In addition, DTA 340 informs TM 330 that the command execution ended. As a result, TM 330 removes the command from the queue and iSCSI model 320 sends a response command to the host. The response command signals the end of the SCSI command.

Virtualization switch 200 buffers the data before writing and reading from or to the physical storage devices. In one embodiment the memory buffers used are scatter gather lists (SGLs) that are composed of multiple data segments linked together using a linked list. A SGL represents a logical contiguous buffer.

In one embodiment the present invention provides a software mechanism that determines which errors should be reported by the virtual volume. Specifically, a virtual volume consists of more than one physical storage devices. Hence, an error generated by only one of the physical volumes may not affect the functionality of the virtual volume and therefore this error should not be reported to the user. To determine whether or not to report a virtual volume error, the virtualization switch 200 aggregates the errors produced by the physical storage devices for each of the virtual volumes. Based on the number of errors, the error types, and decision criteria, virtualization switch 200 determines whether or not to report a virtual volume error. The decision criteria may be defined by the user or may be set dynamically according to the currently available resources.

In one embodiment the present invention provides a bridge mechanism that allows transfers of data from the hosts to physical storage devices, and vice versa. The data transportation is executed transparently without performing any virtualization operations. The bridge mechanism can operate a storage switch in storage area network (SAN), network attached storage (NAS), and the others.

The invention has now been described with reference to specific embodiments. Other embodiments will be apparent to those of ordinary skill in the art. For example, the invention has been described with respect to a SCSI protocol. The invention can be modified to apply to any other type of protocols, which are used to write and read data from storage devices connected to a network.

1. A virtualization switch for performing a plurality of virtualization services within a data path said virtualization switch comprises at least:
a network interface (NI);
an iSCSI module;
a target manager (TM);
a volume manager (VM);
a data transfer arbiter (DTA);
a device manager (DM);
a plurality of input ports to receive incoming packets from a network; and,
a plurality of output ports to communicate with plurality of storage devices.

2. The virtualization switch of claim 1, wherein said virtualization switch is capable of operating in at least one of: storage area network (SAN), network attached storage (NAS).

3. The virtualization switch of claim 1, wherein said data path is established between a host and said storage devices.

4. The virtualization switch of claim 1, wherein said virtualization services comprise at least one of: mirroring, remote mirroring over a slow link, snapshot, data replication, striping, concatenation, periodic local and remote backup, restore.

5. The virtualization switch of claim 1, wherein said network is at least one of: local area network (LAN), wide area network (WAN), geographically distributed network.

6. The virtualization switch of claim 1, wherein said storage device is at least one of: tape drive, optical drive, disk, sub-disk, redundant array of inexpensive disks (RAID).

7. The virtualization switch of claim 1, wherein said input ports are capable of carrying packets in accordance with a transport protocol.

8. The virtualization switch of claim 7, wherein said transport protocol is at least one of:
Fiber Cannel (FC), parallel small computer system interface (SCSI), internet small computer system interface (iSCSI), transmission control protocol (TCP)/internet protocol (IP), Infiniband.

9. The virtualization switch of claim 1, wherein said output ports are capable of carrying packets in accordance with a transport protocol.

10. The virtualization switch of claim 9, wherein said transport protocol is at least one of:
Fiber Cannel (FC), parallel SCSI, iSCSI, TCP/IP, Infiniband.

11. The virtualization switch of claim 1, wherein said NI further comprises a TCP/IP stack for the purpose of accelerating TCP/IP packets processing.

12. The virtualization switch of claim 1, wherein said iSCSI module further comprises an iSCSI stack for the purpose of handling an iSCSI protocol.

13. The virtualization switch of claim 1, wherein said TM comprises instructions for the purpose of:
handling incoming logic commands; and,
scheduling the execution of said incoming logic commands.

14. The virtualization switch of claim 13, wherein said logic command refers to a virtual volume and a virtual address space.

15. The virtualization switch of claim 13, wherein said logic command is at least SCSI command.

16. The virtualization switch of claim 13, wherein said TM further comprises a plurality of host-logical unit (LU) queues, wherein each of said host-LU queue contains said logic commands requested to be executed by said host on said LU.

17. The virtualization switch of claim 16, wherein said LU comprises a plurality of contiguous partitions of storage space on said storage device.

18. The virtualization switch of claim 1, wherein said DTA is capable of handling data transfer between said storage devices and hosts.

19. The virtualization switch of claim 1, wherein said VM is capable of translating a logic command to a list of physical commands.

20. The virtualization switch of claim 19, wherein each of said physical commands includes at least: a physical address of a single storage device.

21. The virtualization switch of claim 18, wherein said physical commands are constructed in a data structure, said data structure defines the relations between said physical commands.

22. The virtualization switch of claim 21, wherein said data structure comprises at least one of: alternative command link, pointer to said storage device.

23. The virtualization switch of claim 22, wherein said alternative command link links between at least two physical commands that can be executed in parallel.

24. The virtualization switch of claim 21, wherein said VM further comprises a mapping schema uses for translating said logic command to said list of said physical commands.

25. The virtualization switch of claim 24, wherein said mapping schema defines relations between virtual volumes, logical units (LUs), and said storage devices.

26. The virtualization switch of claim 25, wherein said virtual volume is at least one of:
concatenation volume, stripe volume, mirrored volume, simple volume, snapshot volume.

27. The virtualization switch of claim 1, wherein said DM comprises at least:
a list of target paths; and,
a list of LU paths associated with each of said target paths.

28. The virtualization switch of claim 27, wherein each of said target paths defines a connection between said virtualization switch and one of said storage devices, via one of said output ports.

29. The virtualization switch of claim 27, wherein said DM further comprises a plurality of storage drivers for communicating with said plurality of output ports.

30. The virtualization switch of claim 1, wherein said virtualization switch further provides a bridge mechanism for transferring data without performing said virtualization services.

31. The virtualization switch of claim 1, wherein said virtualization switch is further capable of reporting on error generated by virtual volumes.

32. A method for performing a plurality virtualization services, said method being further operative to perform said virtualization services within a data path, said method comprises the steps of:
a) receiving a logic command to be performed on at least one virtual volume, said logic command including at least a virtual address;
d) scheduling said logic command for execution;
c) translating, in one pass, said logic command to a list of physical commands, wherein each of said physical commands is targeted to a different storage device;
d) determining the amount of data to be transferred via a network; and,
e) executing said physical commands on said storage devices.

33. The method of claim 32, wherein said virtualization services comprise at least one of:
mirroring, remote mirroring over a slow link, snapshot, data replication, striping, concatenation, periodic local and remote backup, restore.

34. The method of claim 32, wherein said data path is established between a host and said storage devices.

35. The method of claim 32, wherein said storage device is at least one of: a tape drive, optical drive, disk, sub-disk, redundant array of inexpensive disks (RAID).

36. The method of claim 32, wherein said logic command is at least a SCSI command.

37. The method of claim 36, the following steps comprise receiving said logic command:
a) initiating an iSCSI session with an initiator host;
b) receiving said logic command from said initiator host;
c) parsing said logic command to determine at least said virtual address and said logic command's type;
d) performing a check to determine if said logic command is valid;
e) generating a response command if said logic command is invalid, otherwise, adding said logic command to a host-LU queue; and,
f) generating a data transfer request.

38. The method of claim 37, wherein the following steps further comprise initiating said iSCSI session:
a) determining if said initiator host is authorized to send said logic command; and,
b) denying said logic command from said initiator host, if said initiator host is unauthorized.

39. The method of claim 37, wherein said response command comprises an iSCSI service response code indicating the type of a generated error.

40. The method of claim 37, wherein said host-LU queue comprises logic commands requested to be executed by said host on said LU.

41. The method of claim 37, wherein scheduling said logic command for execution further comprises the step of: selecting said logic command to be executed from said host-LU queue.

42. The method of claim 41, wherein the selection is performed using at least one of the following selection algorithms: recently used, round robin, weighted round robin, random, least loaded LU.

43. The method of claim 37, wherein said command type is a read command.

44. The method of claim 43, wherein said amount of data to be transferred is determined by an available space parameter.

45. The method of claim 44, wherein said available space parameter defines the number of data bytes to be sent to the host.

46. The method of claim 44, wherein the following steps comprise executing said physical commands on said storage devices:
a) accessing a storage device using a physical address;
b) retrieving from said accessed storage device the number of bytes designated in said available space parameter;
c) sending the retrieved data to said host; and,
d) repeating said steps a) through d) until all requested data is read from said storage devices.

47. The method of claim 46, wherein said physical commands are executed in parallel.

48. The method of claim 37, wherein said command type is a write command.

49. The method of claim 48, wherein said amount of data to be transferred is determined by a check-point list.

50. The method of claim 49, wherein said check-point list defines how data should be sent from an initiator host to said storage devices.

51. The method of claim 50, wherein said check-point list comprises a linked list of data chunks.

52. The method of claim 51, wherein the following steps comprise executing said physical commands on said storage devices:
a) filling at least one data chunk with said data retrieved from the network;
b) accessing said storage device using a physical address;
c) writing said data chunk to said accessed storage device; and,
d) repeating said steps a) through d) for all data chunks in said check-point list.

53. The method of claim 52, wherein said physical commands are executed in parallel.

54. The method of claim 32, wherein said physical commands are constructed in a data structure.

55. The method of claim 54, wherein said data structure further includes at least one of: an alternative command link, a pointer to said storage device.

56. The method of claim 55, wherein said alternative command link links between at least two physical commands that can be executed in parallel.

57. The method of claim 32, wherein translating said logic command to said list of physical commands is performed using a mapping schema.

58. The method of claim 57, wherein said mapping schema defines relations between virtual volumes, logical units (LUs), and said storage devices.

59. The method of claim 32, wherein upon completing the execution of said physical commands further comprises the steps of:
a) removing said logic command from the host-LU queue;
b) sending to the initiator host a response command, said response command signals the end of execution.

60. The method of claim 32, wherein said method is further capable to perform operations on said virtual volumes that do not require any data transfer.

61. The method of claim 32, wherein said method is further capable of reporting on errors generated by virtual volumes.

62. A computer executable code for performing a plurality virtualization services, said computer executable code being further operative to perform said virtualization services within a data path, said code comprises the steps of:
a) receiving a logic command to be performed on at least one virtual volume, said logic command including at least a virtual address;
d) scheduling said logic command for execution;
c) translating, in one pass, said logic command to a list of physical commands, wherein each of said physical commands is targeted to a different storage device;
d) determining the amount of data to be transferred via a network; and,
e) executing said physical commands on said storage devices.

63. The computer executable code of claim 62, wherein said virtualization services comprise at least one of: mirroring, remote mirroring over a slow link, snapshot, data replication, striping, concatenation, periodic local and remote backup, and restore.

64. The computer executable code of claim 62, wherein said data path is established between a host and said storage devices.

65. The computer executable code of claim 62, wherein said storage device is at least one of: tape drive, optical drive, disk, sub-disk, redundant array of inexpensive disks (RAID).

66. The computer executable code of claim 62, wherein said logic command is at least a SCSI command.

67. The computer executable code of claim 66, the following steps comprise receiving said logic command:
a) initiating an iSCSI session with an initiator host;
b) receiving said logic command from said initiator host;
c) parsing said logic command to determine at least said virtual address and said logic command's type;
d) performing a check to determine if said logic command is valid, e) generating a response command if said logic command is invalid, otherwise, adding said logic command to a host-LU queue; and,
f) generating a data transfer request.

68. The computer executable code of claim 67, wherein the following steps further comprise initiating said iSCSI session:
a) determining if said initiator host is authorized to send said logic command; and,
b) denying said logic command from said initiator host, if said initiator host is unauthorized.

69. The computer executable code of claim 67, wherein said response command comprises an iSCSI service response code indicating the type of error.

70. The computer executable code of claim 67, wherein said host-LU queue comprises logic commands requested to be executed by said host on said LU.

71. The computer executable code of claim 67, wherein scheduling said logic command for execution further comprises the step of: selecting said logic command to be executed from said host-LU queue.

72. The computer executable code of claim 71, wherein the selection is performed using at least one of the following selection algorithms: recently used, round robin, weighted round robin, random, least loaded LU.

73. The computer executable code of claim 67, wherein said command type is a read command.

74. The computer executable code of claim 73, wherein said amount of data to be transferred is determined by an available space parameter.

75. The computer executable code of claim 74, wherein said available space parameter defines the number of data bytes to be sent to the initiator host.

76. The computer executable code of claim 73, wherein the following steps comprise executing said physical commands on said storage devices:
a) accessing a storage device using a physical address;
b) retrieving from said accessed storage device the number of bytes designated in said available space parameter;
c) sending the retrieved data to said host; and,
d) repeating said steps a) through d) until all requested data is read from said storage devices.

77. The computer executable code of claim 76, wherein said physical commands are executed in parallel.

78. The computer executable code of claim 67, wherein said command type is a write command.

79. The computer executable code of claim 78, wherein said amount of data to be transferred is determined by a check-point list.

80. The computer executable code of claim 79, wherein said a check-point list defines how data should be sent from the initiator host to said storage devices.

81. The computer executable code of claim 80, wherein said check-point list comprises a linked list of data chunks.

82. The computer executable code of claim 81, wherein the following steps comprise executing said physical commands on said storage devices:
a) filling at least one data chunk with said data retrieved from the network;
b) accessing said storage device using a physical address;
c) writing said data chunk to said accessed storage device; and,
d) repeating said steps a) through d) for all data chunks in said check-point list.

83. The computer executable code of claim 82, wherein said physical commands are executed in parallel.

84. The computer executable code of claim 83, wherein said physical commands are constructed in a data structure.

85. The computer executable code of claim 84, wherein said data structure further includes at least one of: an alternative command link, a pointer to said storage device.

86. The computer executable code of claim 85, wherein said alternative command link links between at least two physical commands that can be executed in parallel.

87. The computer executable code of claim 62, wherein translating said logic command to said list of physical commands is performed using a mapping schema.

88. The computer executable code of claim 87, wherein said mapping schema defines relations between virtual volumes, logical units (LUs), and said storage devices.

89. The computer executable code of claim 62, wherein upon completing the execution of said physical commands further comprises the steps of:
a) removing said logic command from the host-LU queue;
b) sending to the initiator host a response command, said response command signals the end of execution.

90. The computer executable code of claim 62, wherein said code is further capable to perform operations on said virtual volumes that do not require any data transfer.

91. The computer executable code of claim 62, wherein said method is further capable of reporting on errors generated by virtual volumes.
